(19) United States
(12) Patent Application Publication
(10) Pub. No.: US 2015/0276163 A1
(43) Pub. Date: Oct. 1, 2015

(54) DEFROST STRUCTURE FOR VEHICLE HEADLIGHTS

(71) Applicant: FUJIKURA LTD., Tokyo (JP)

(72) Inventors: Randeep SINGH, Koto-ku (JP); Masataka MOCHIZUKI, Koto-ku (JP)

(73) Assignee: FUJIKURA LTD., Tokyo (JP)

(21) Appl. No.: 14/662,368

(22) Filed: Mar. 19, 2015

(30) Foreign Application Priority Data
Mar. 26, 2014 (JP) 2014-064699

(51) Int. Cl. F21S 8/10

(52) U.S. Cl. CPC F21S 48/34; F21S 48/13; F21S 48/328; F21S 48/115

(57) ABSTRACT

The defrost structure for a vehicle headlight is provided. In the defrost structure, an LED 2 arranged in a housing 10 is connected to a heat sink 20 through a heat pipe 40. The heat sink 20 comprises a base plate 21 closing a rear opening of the housing 10, and fins 22 erected on the base plate 21 vertically to protrude forward in the housing 10. An air flow channel X is formed to allow air warmed by the fins 22 to flow toward an inner surface 11a of a lens 11. An upper side 22a of each fin 22 serves as the air flow channel X.

This patent invention claims the benefit of Japanese Patent Application No. 2014-064699 filed on Mar. 26, 2014, the disclosure of which is incorporated herein by reference in its entirety.

### BACKGROUND OF THE INVENTION

1. Field of the Invention

The present invention relates to a defrost structure for vehicle headlights.

2. Description of the Related Art

As widely known, a vehicle headlight is attached to a vehicle frame in the form of unit. The conventional headlight assembly comprises a sealed casing holding a light source therein, and optionally, the casing may be provided with an opening serving as an air intake.

In the conventional art, a halogen lamp or a light source having no filament such as an HID lamp that emits light by arc discharge or a light emitting diode (LED) may be used as a light source of the headlight. For example, JP-A-No. 2009-87620 and JP-A-No. 2006-164967 respectively describe a vehicle headlight using an LEDs as a light source.

According to the teachings of JP-A-No. 2009-87620, the vehicle headlight is provided with a sealed housing holding an LED liquid-tightly. An opening is formed on a rear surface of the housing, and a base portion of a heat sink is fitted into the opening. Fins of the heat sink are exposed to the outside of the housing so as to enhance heat radiation. Furthermore, the LED is connected to the heat sink through a flexible heat conduction member attached to the base portion of the heat sink to exchange heat therebetween.

In the vehicle headlight taught by JP-A-No. 2006-164967, an LED is connected to a heat sink through a loop type heat pipe to exchange heat therebetween. This heat sink has a base plate functioning as a heat radiation plate, and the base plate is fitted into an opening of a housing. A groove for fixing the heat pipe is formed on an inner surface of the base plate, and one of end portions of the heat pipe is fitted into the groove. A plurality of heat radiation fins are erected on an outer surface of the base plate while being exposed to the external air.

In recent years, vehicle headlights using laser beams as irradiation lights have been developed. In the vehicle headlight thus structured, a laser diode (LD) and a phosphor are used as light sources, and a laser beam emitted from the LD ahead of the vehicle is excited by the phosphor.

White light emitted from the LED has less infrared rays than that emitted from a halogen lamp. In the headlights taught by JP-A-No. 2009-87620 and JP-A-No. 2006-164967, therefore, an inner surface of the case, a reflection plate, an inner surface of an lens etc. will not be heated excessively by the light emitted from the LED. However, although a calorific value of the LED is smaller than that of the halogen lamp, the housing is still heated locally by the LED.

In addition, the external air is not allowed to enter into the sealed housing and hence dew condensation occurs in the housing. Therefore, when an external temperature is relatively low in winter season or the like, a surface temperature of an lens is lowered to a dew-point to cause dew condensation on the inner surface of the lens. Further, given that the LED is employed to serve as a light source of the headlight, a temperature in the housing will not be raised promptly and humidity in the housing will not be decreased easily.

Therefore, in the vehicle headlights taught by JP-A-No. 2009-87620 and JP-A-No. 2006-164967, water droplets produced by the dew condensation may possibly remain in the housing. Adhesion of the water droplets to the inner surface of the lens may cause diffused reflection of light transmitting therethrough and the light illuminating ahead of the vehicle may be weakened. In addition, if the LED is exposed in a space divided by the inner surface of the lens in the housing as taught by JP-A-No. 2009-87620, the water droplets condensed on the inner surface of the lens may possibly come into contact with the LED. In this case, the water droplets cause a failure or a malfunction of the LED, and durability of the headlight may be degraded.

### SUMMARY OF THE INVENTION

In view of the above-described technical problems, it is therefore an object of the present invention to provide a defrost structure for vehicle headlights for cooling a light-emitting diode serving as a light source while preventing dew condensation in a housing utilizing heat of the light-emitting diode.

The defrost structure for a vehicle headlight according to the present invention is comprised of: a light-emitting diode serving as a light source arranged in a housing; a heat sink comprising a base plate attached to a rear opening of the housing to close the housing hermetically, and a plurality of fins erected on the base plate vertically to protrude forward in the housing; a heat pipe thermally connecting the light-emitting diode to the heat sink; a reflector that is disposed in front of the heat sink and that is curved forward from a lower end to an upper end to shroud the light-emitting diode from above; and an air flow channel that allows air warmed by the fins to flow toward an inner surface of a lens hermetically closing a front opening of the housing through between an upper end of the reflector and a top plate of the housing. A front side of each of the fin is individually contoured to the rear surface of the reflector, and an upper side of each of the fin is individually aligned with the upper end of the reflector to serve as the air flow channel. In addition, a surface area of an upper portion of each of the fin is larger than that of a lower portion thereof.

Specifically, a vertical length of each of the fin is longer than a horizontal length thereof, and the horizontal length of an upper side of each of the fin is longer than that of a lower side thereof.

In addition, the heat pipe penetrates through the fins of the heat sink.

In the defrost structure, a front face of the base plate serves as an inner wall surface of the housing, and a rear face thereof serves as an outer wall surface of the housing. The fins are erected on the front face of the base plate, and the heat pipe may also be inserted into the base plate of the heat sink.

The heat sink further comprises a plurality of outer fins erected on the base plate of the heat sink to protrude outside of the housing.

The outer fins are erected vertically on the rear face of the base plate of the heat sink. A vertical length of each of the outer fin is also longer than a horizontal length thereof, and the horizontal length of an upper side of the fin is also longer than that of a lower side thereof.

According to the present invention, therefore, the light emitting diode can be cooled effectively while defrosting an inner surface of the housing including an inner surface of the lens. Specifically, a chimney effect can be achieved by the fins so that heat of the light-emitting diode can be diffused entirely in the housing by natural convection. That is, air warmed by the fins is allowed to flow toward the lens through the air flow channel formed above the upper side of the fins thereby creating the natural convection. For this reason, the air warmed behind the reflector is allowed to flow toward the inner surface of the lens situated in front of the reflector.

In other words, a heat capacity of the lower portion of the fin is smaller than that of the upper portion so that a temperature of the lower portion of the fin is raised faster than that of the upper portion to enhance the chimney effect.

As described, according to the present invention, fins are erected vertically on the heat sink so that ascending stream of the warmed air can be expedited. In addition, since the vertical length of the fin is longer than the horizontal length thereof, the chimney effect can be further enhanced. Likewise, since the horizontal length of the upper side of the fin is longer than that of the lower side, the air warmed by the fins is allowed to flow into the air flow channel easily.

According to the present invention, since the heat pipe penetrates through the fins, the heat of the light-emitting diode can be transported efficiently to the fins and radiated from the fins effectively.

According to another aspect of the present invention, heat radiation from the rear face of the heat sink can be enhanced by inserting the heat pipe into a side face of the heat sink.

According to still another aspect of the present invention, heat radiation to the outside can be further enhanced by the outer fins erected on the rear face of the heat sink.

The chimney effect can also be achieved by the outer fins so that the heat radiation to the outside thorough the heat sink can be further enhanced. In this case, a heat capacity of the lower portion of the outer fin is also smaller than that of the upper portion so that a temperature of the lower portion of the outer fin is also raised faster than that of the upper portion to enhance the chimney effect.

### BRIEF DESCRIPTION OF THE DRAWINGS

Features, aspects, and advantages of exemplary embodiments of the present invention will become better understood with reference to the following description and accompanying drawings, which should not limit the invention in any way.

FIG. 1 is a cross-sectional view schematically showing the defrost structure for the vehicle headlight according to a first example;

FIG. 2 is a perspective view showing the defrost structure of the first example in the housing illustrated in FIG. 1;

FIG. 3 is a cross-sectional view showing natural convection produced in the vehicle headlight having the defrost structure shown in FIG. 2;

FIG. 4 is an air diagram explaining an air state in the housing;

FIG. 5 is a cross-sectional view schematically showing the defrost structure for the vehicle headlight according to a second example;

FIG. 6 is a perspective view showing the defrost structure of the second example in the housing illustrated in FIG. 5;

FIG. 7 is a cross-sectional view schematically showing the defrost structure for the vehicle headlight according to a third example; and

FIG. 8 is a perspective view showing the defrost structure of the third example in the housing illustrated in FIG. 7.

### DETAILED DESCRIPTION OF THE PREFERRED EMBODIMENT(S)

A defrost structure for vehicle headlights according to the present invention will now be described hereinafter based on specific examples with reference to the accompanying drawings.

### First Example

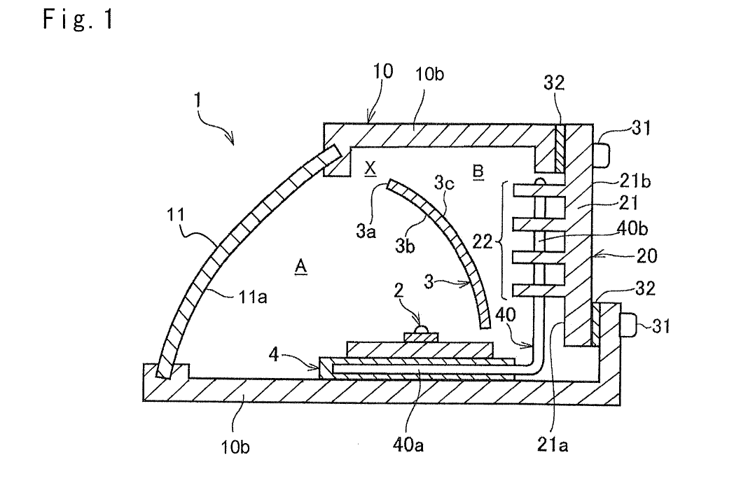

A defrost structure for a vehicle headlight according to a first example will now be explained with reference to FIG. 1. As described later, according to the first example, there are two heat pipes 40 and 41 are arranged in the vehicle headlight 1 shown in FIG. 1. However, only the first heat pipe 40 is shown in FIG. 1 for the sake of illustration. Also, although a fin array 22 is erected vertically according to the first example, the fin array 22 is illustrated horizontally for the sake of illustration. In the vehicle headlight 1 shown in FIG. 1, a light-emitting diode (abbreviated as the “LED” hereinafter) 2 functioning as a light source and a reflector 3 are held in a sealed housing 10. In the defrost structure of the present invention, a well-known LED package is employed as the LED 2, and the LED 2 is exposed to an internal atmosphere of the housing 10 while being connected to a heat sink 20 as a heat radiator through the heat pipes 40 and 41 to transfer heat thereof to the heat sink 20.

The housing 10 is comprised of a bottom plate 10a, a top plate 10b, a front opening, and a rear opening. A lens 11 closes the front opening of the housing 10 hermetically while inclining in a manner such that a lower portion thereof protrudes frontward from an upper portion thereof, and the heat sink 20 made of a metal closes the rear opening of the housing 10.

The heat sink 20 is comprised of a base plate 21 and a plurality of fins forming the fin array 22 erected on a front face 21a of the base plate 21 while being juxtaposed to one another. That is, those fins 22 protrude toward an inner space of the housing 10, and a rear face 21b of the base plate 21 is exposed to an external atmosphere. Here, the fin 22 may also be formed into a rod-shape instead of a plate shape.

A connection between the heat sink 20 and the housing 10 is also sealed liquid-tightly by a sealing member 32 interposed therebetween, and the base plate 21 of the heat sink 20 is fixed to the rear opening of the housing 10 by bolts 31.

The connection between the heat sink 20 and the housing 10 will be explained in more detail. Specifically, a flange is formed on a rear end of the top plate 10b, and an upper end of the base plate 21 of the heat sink 20 is fixed to an outer surface of the flange through the sealing member 32 by the bolt 31. A flange is also formed on a rear end of the bottom plate 10a, and a lower end of the base plate 21 of the heat sink 20 is fixed to an inner surface of the flange through the sealing member 32 by the bolt 31.

In the housing 10, the LEDs 2 are arranged to emit light upwardly, and the reflector 3 is adapted to reflect light emitted from the LEDs 2 toward the lens 11 situated on the front side. To this end, the reflector 3 is disposed in front of the base plate 21 in a manner to shroud the LEDs 2 from above.

Specifically, the reflector 3 is curved forward from a lower end thereof to the upper end 3a thereof to shroud the LEDs 2 from above. That is, the upper end 3a of the reflector 3 is situated at a front end of the reflector 3. Accordingly, the front surface 21a of the base plate 21 is opposed to a rear surface 3c of the reflector 3 so that the fins 22 protrude toward the rear surface 3c of the reflector 3.

A clearance between the upper end 3a and the top plate 10b serves as an air flow channel X. In the housing 10, therefore, air warmed by the fin array 22 of the heat sink 20 is allowed to flow toward an inner surface 11a of the lens 11 through the air flow channel X thus formed in the vicinity of the top plate 10b.

That is, in the housing 10, the air in an inner space B between the rear surface 3c of the reflector 3 and the fin array 22 of the heat sink 20 is allowed to flow toward an inner space A between a reflection surface 3b of the reflector 3 and the inner surface 11a of the lens 11 through the air flow channel X.

According to the first example, heat of the LED 2 is transported to the fin array 22 of the heat sink 20 through the heat pipes 40 and 41 respectively comprising a metal sealed container and a phase-changeable working fluid encapsulated in the container. That is, the heat of the LED 2 is transported in the form of latent heat of the working fluids of the heat pipes 40 and 41. In addition, The LED 2 is individually laid on a heat collection member 4 disposed on the bottom plate 10a of the housing 10. Specifically, the heat collection member 4 is a rectangular parallelepiped heat collection block made of material having high heat conductivity. One of end portions of the first heat pipe 40 and one of end portions of the second heat pipe 41 are individually contacted to the heat collection member 4 to serve as evaporating portions 40a and 41a, and other end portions of the heat pipes 40 and 41 penetrate through the fin array 22 to serve as condensing portions 40b and 41b.

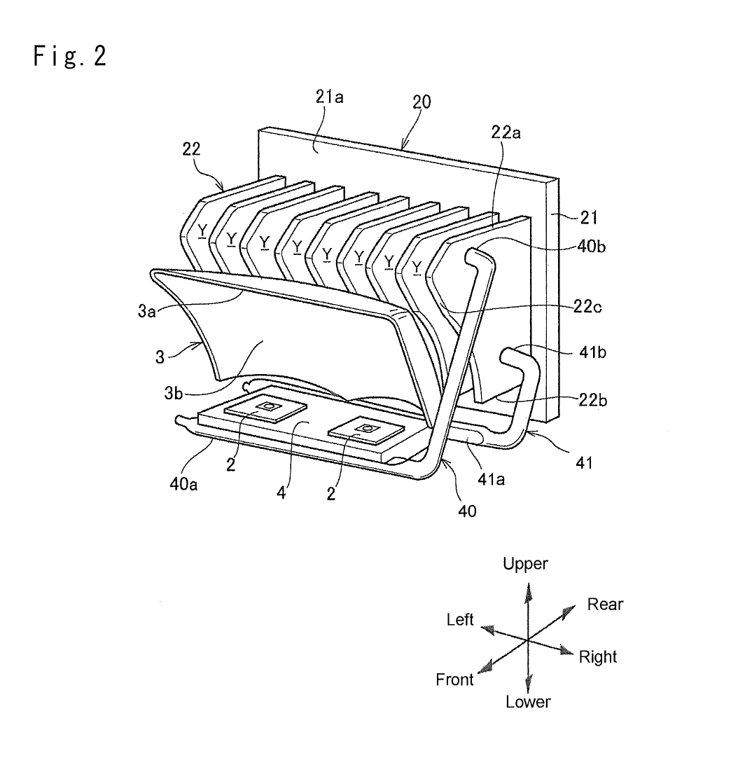

The heat sink 20 and the heat pipes 40 and 41 will now be described in more detail with reference to FIG. 2. As shown in FIG. 2, the base plate 21 of the heat sink 20 is erected behind the reflector 3, and the fin array 22 protrudes vertically toward the reflector 3. Each clearance between the fins 22 serves as an air flow channel Y allowing the air to flow vertically therethrough. Further, a vertical length of each fin 22 is longer than a horizontal length thereof, and each fin 22 is preferably formed to have a high aspect ratio. Here, it is easier for the air to flow upwardly through a clearance between plate fins 22 in comparison with that between columnar fins. For this reason, the plate fins 22 are employed in the preferred examples.

A front side 22c of each fin 22 is contoured to the rear surface 3c of the reflector 3 so that an upper side 22a of the fin 22 is longer than a lower side 22b. According to the example shown in FIG. 2, the upper side 22a of each fin 22 is situated above the upper end 3a of the reflector 3, and the front side 22c is situated behind the upper end 3a of the reflector 3. Alternatively, the front side 22c of the fin 22 may also be protruded to cover the upper end 3a of the reflector 3 from above. That is, the upper side 22a of the fin 22 serves as the below-mentioned air flow channel X.

Through holes to which the heat pipes 40 and 41 are inserted in a thickness direction are formed on each fin 22. The heat pipes 40 and 41 are individually bent into a U-shape, and the condensing portion 40b and 41b of the heat pipes 40 and 41 are individually inserted into those through holes of the fin array 22 while being contacted therewith.

A pair of LEDs 2 is disposed on an upper surface of the heat collection member 4 while aligning long sides thereof in the lateral direction. In the LED 2, an LED chip is disposed on a square substrate while being connected to a not shown electronic circuit so that the LED 2 is allowed to emit light by applying a current to the electronic circuit.

According to the preferred examples, number of heat pipe(s) to be arranged is not limited to specific number, and as has been described, two heat pipes 41 and 42 are arranged in the first example shown in FIG. 2. Specifically, the evaporating portion 40a of the first heat pipe 40 extends along the front long side of a bottom face of the heat collection member 4 while being contacted therewith, and the condensing portion 40b thereof is inserted into the upper through hole of the fin array 22. On the other hand, the evaporating portion 41a of the second heat pipe 41 extends along the rear long side of a bottom face of the heat collection member 4 while being contacted therewith, and the condensing portion 41b thereof is inserted into the lower through hole of the fin array 22. Here, an area of an upper portion of the fin 22 where the upper through hole is formed is larger than that of a lower portion thereof where the lower through hole is formed.

When the headlight 1 is turned on, heat of the LED 2 is conducted to the heat collection member 4, and the heat conducted to the heat collection member 4 propagates radially around the LED 2. Then, the heat of the heat collection member 4 is transported to the heat sink 20 through the heat pipes 40 and 41 to be radiated through the fin array 22. Thus, in the headlight 1, the heat of the LED 2 is diffused in the housing 10 and hence the LED 2 will not serve as a heat spot.

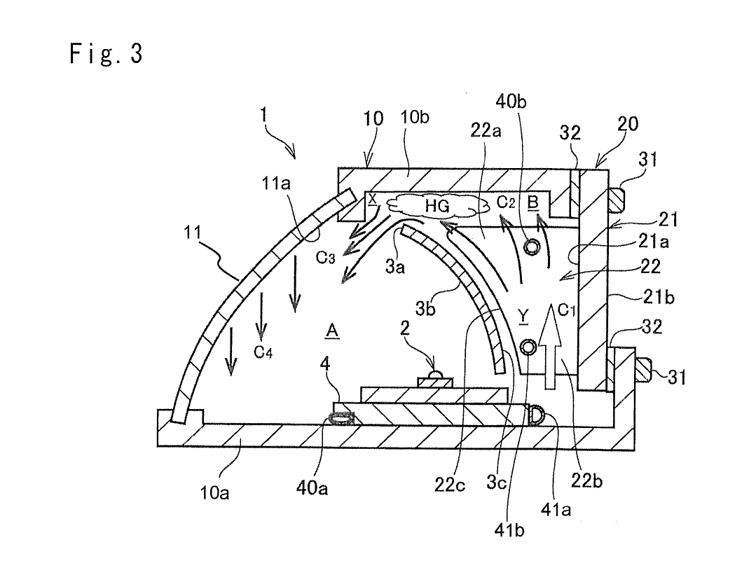

Here will be explained natural convection produced in the internal space of the housing 10 with reference to FIG. 3. A white arrow shown in FIG. 3 indicates natural convection C1 produced by radiating the heat of the LED 2 through the fin array 22. Specifically, when air in a rear space B is warmed by the fins 22, natural convection C1 of the air ascending through the air flow channels Y between the fins 22 is produced by the chimney effect. Consequently, the air warmed in the air flow channels Y flows out of the fin array 22 to produce natural convection C2 above the upper sides 22a of the fins 22.

A vertical length of each fin 22 is longer than the horizontal length of the upper side 22a so that the chimney effect in each air flow channel Y can be promoted. In addition, since the lower side 22b of each fin 22 is shorter than the upper side 22a, a surface area of the lower portion of the fin 22 is smaller than that of the upper portion thereof. Therefore, a heat capacity of the lower portion of the fin 22 is smaller than that of the upper portion thereof so that a temperature of the lower portion of the fin 22 is raised faster than that of the upper portion. For this reason, the ascending natural convection C1 is promoted in each air flow channel Y.

As shown in FIG. 3, the horizontal length of the upper side 22a of each fin 22 is longer than that of the lower side 22b thereof, and front side 22c thereof is curved along the rear surface 3c of the reflector 3. Therefore, the natural convection C2 is guided to flow in the forward direction. In addition, since an upper end of the front side 22c protrudes to the vicinity of the upper end 3a of the reflector 3, the natural convection C2 is further promoted in the vicinity of the upper end 3a. Consequently, natural convection C3 flows downwardly into a front space A from the rear space B through the air flow channel X.

That is, air HG warmed by the fin array 22 flows out of the air flow channel Y and floats between the upper side 22a of the fin array 22 and the top plate 10b in the rear space B. Then, the warmed air HG flowing in the vicinity of the top plate 10b is swept downwardly into the air flow channel X by the natural convection C2 flowing in the front direction.

Then, the natural convection C3 in the inner space A flows toward the lens 11 so that the warm air contained in the natural convection C3 comes into contact with the inner surface 11a of the lens 11. Consequently, heat of the natural convection C3 is drawn by the inner surface 11a of the lens 11 so that natural convection C4 flowing downwardly in the inner space A is created. That is, the natural convection C4 is cooler than the natural convection C3.

Thus, the heat generated by the LED 2 can be transported to the inner surface 11a of the lens 11 by the natural convections C1, C2, and C3 circulating in the housing 10. Consequently, the inner surface 11a of the lens 11 can be warmed by the heat of the LED 2 transported thereto. In addition, the LEDs 2 can be cooled by the natural convection C4 flowing toward the bottom plate 10a of the housing 10 in the inner space A. Further, since the lens 11 is inclined backwardly, an upper portion of the inner surface 11a can be brought into contact effectively with the natural convection C3 flowing through the air flow channel X.

That is, the heat generated by the LEDs 2 can be diffused effectively in the entire inner space of the housing 10 by the natural convection created by the fin array 22 of the heat sink 20 arranged in the inner space B. Consequently, a temperature of the air in the housing 10 is raised so that internal heat of the housing 10 can be radiated efficiently to the outside through the walls of the housing 10. In addition, the temperature of the inner surface 11a of the lens 11 can be raised during the heat radiation through the housing 10.

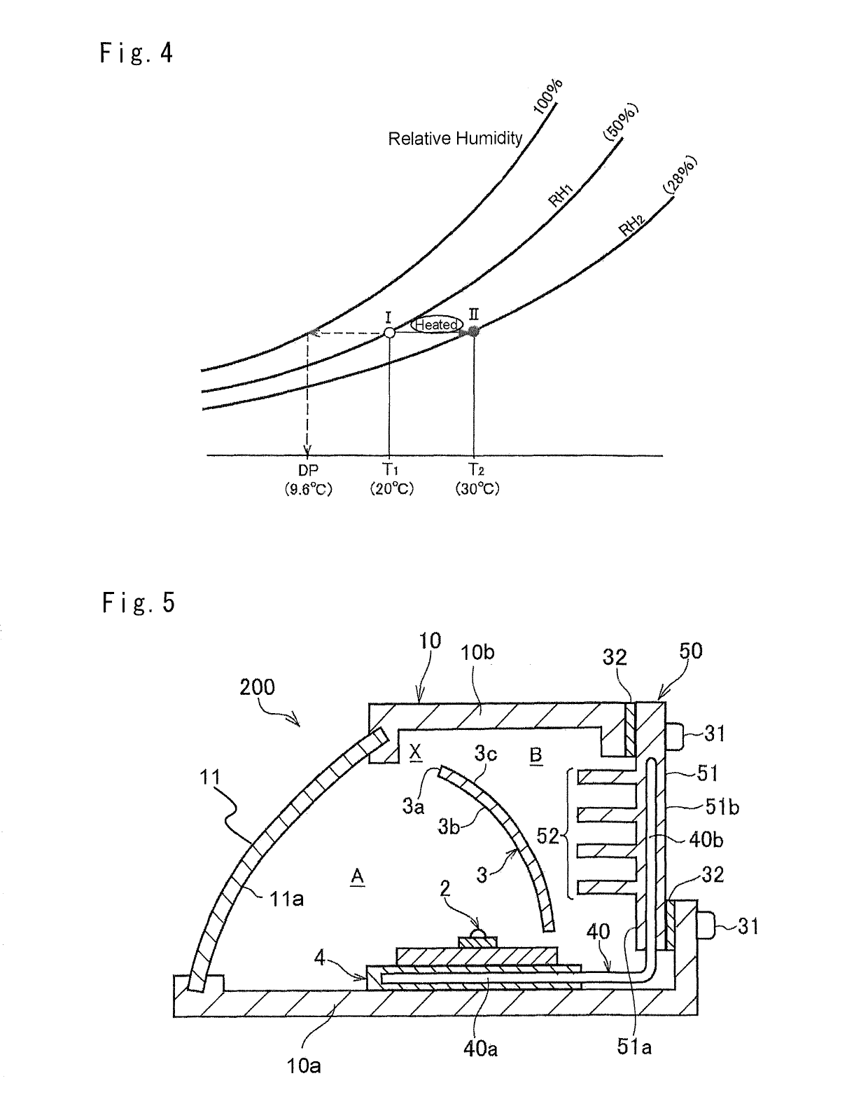

Here will be explained a state of the air in the housing 10 with reference to an air diagram shown in FIG. 4. In FIG. 4 a point “I” represents a situation that the headlight 1 is off, and a point “II” represents a situation that the headlight 1 is on.

As shown in FIG. 4, at the point I where the headlight 1 is off, a temperature T1 in the housing 10 is 20 degrees C., relative humidity RH1 is 50%, and a dew-point temperature DP is 9.6 degrees C. Then, when headlight 1 is turned on as represented by the point II, the heat of the LED 2 is diffused in the housing 10 as described above with reference to FIG. 3. In this situation, as shown in FIG. 4, a temperature T2 in the housing 10 is 30 degrees C., relative humidity RH2 is 28%, and a dew-point temperature DP is 9.6 degrees C.

Thus, when the headlight 1 is turned on at the point II, the internal air in the housing 10 is heated by radiating the heat resulting from emitting light from the LED 2 through the fin array 22. Consequently, in FIG. 4, the air state is shifted from the point I to the point II so that the relative humidity is reduced. That is, the relative humidity in the housing 10 can be reduced by turning on the headlight 1 so that the lens inner surface 11a can be defrosted. At the point II, specifically, the internal air whose temperature is 30 degrees C. that is warmer than that of the case in which the headlight 1 is turned on flows into the front space A through the air flow channel X to be contacted with the inner surface 11a of the lens 11. Therefore, a surface temperature of the inner surface 11a will not be lowered to the dew-point temperature 9.6° C. Thus, the inner surface 11a of the lens 11 can be warmed by the natural convection created in the housing 10 thereby eliminating dew condensation on the inner surface 11a.

According to the defrost structure of the first example, therefore, the heat of the LED can be diffused entirely in the inner space of the housing utilizing the natural convection created by the fin array so that the inner surface of the lens can be defrosted effectively. In addition, the heat of the LED can be transported efficiently to the fin array through the heat pipes so that the LED arranged in the sealed housing can be cooled effectively. Further, the housing is warmed entirely by the heat of the internal air so that the heat of the internal air can be radiated externally through the housing.

### Second Example

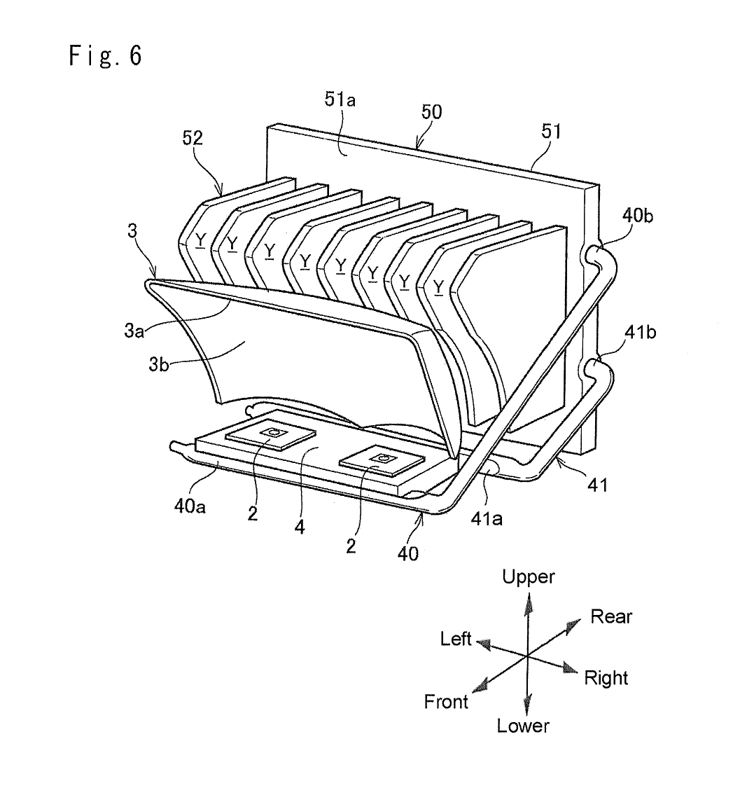

Next, a defrost structure for vehicle headlights according to a second example will be explained with reference to FIGS. 5 and 6. According to the second example, only a connection between the heat sink and the heat pipe is different from that of the first example. In the second example, the reference numerals used in FIGS. 1 to 4 are also allotted to the common elements, and a detailed explanation thereof will be omitted.

According to the second example, there are two heat pipes 40 and 41 are also arranged in the vehicle headlight 200 shown in FIG. 5. However, only the first heat pipe 40 is shown in FIG. 5 for the sake of illustration. Also, although a fin array 52 is erected vertically according to the second example, the fin array 52 is illustrated horizontally for the sake of illustration. As shown in FIG. 5, the evaporating portion 40a of the first heat pipe 40 is also brought into contact with the heat collection member 4 but the condensing portion 40b thereof is inserted into a base plate 51 of a heat sink 50.

As shown in FIG. 6, insertion holes to which the condensing portions 40b and 41b of the heat pipes 40 and 41 are inserted are formed longitudinally on one of side faces of the base plate 51 of the heat sink 50.

Specifically, the evaporating portion 40a of the first heat pipe 40 extends along the front long side of the bottom face of the heat collection member 4 while being contacted therewith, and the condensing portion 40b thereof is inserted into the upper insertion hole of the base plate 51. On the other hand, the evaporating portion 41a of the second heat pipe 41 extends along the rear long side of the bottom face of the heat collection member 4 while being contacted therewith, and the condensing portion 41b thereof is inserted into the lower insertion hole of the base plate 51.

In the defrost structure of the second example, heat of the LED 2 transported to the heat sink 50 through the heat pipes 40 and 41 is conducted to the fin array 52 through the base plate 51. That is, the heat of the LED 2 can be radiated not only to the external atmosphere from a rear face 51b of the base plate 51, but also to the internal atmosphere of the rear space B in the housing 10 from the fin array 52 through a front face 51a of the base plate 51. According to the second example, therefore, a temperature of the base plate 51 is raised faster than that of the fin array 52 so that heat radiation from the rear face 51b of the base plate 51 to the outside of the housing 10 can be enhanced in comparison with the first example.

Thus, according to the second example, the heat radiation from the base plate 51 to the external atmosphere can be enhanced in addition to the advantages of the first example. Therefore, the LEDs serving as light sources can be cooled more efficiently by diffusing the heat thereof in the housing utilizing the natural convection created by the fin array 52.

### Third Example

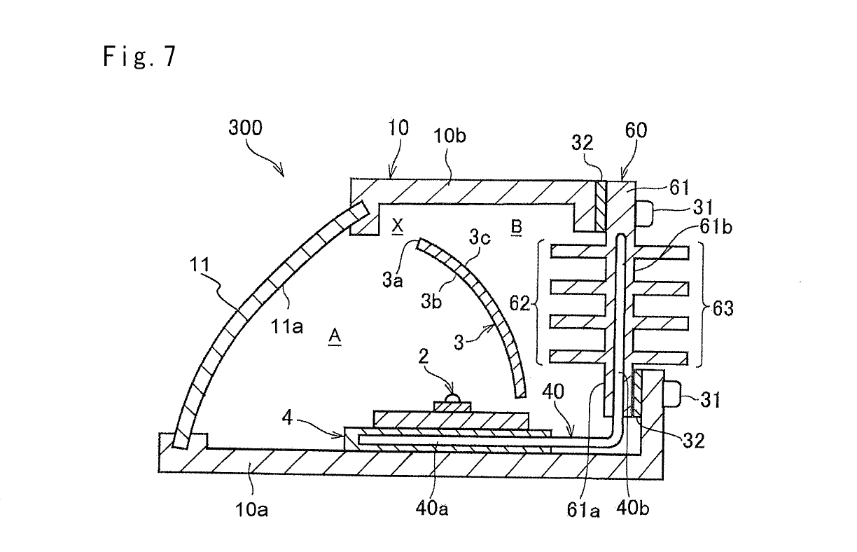

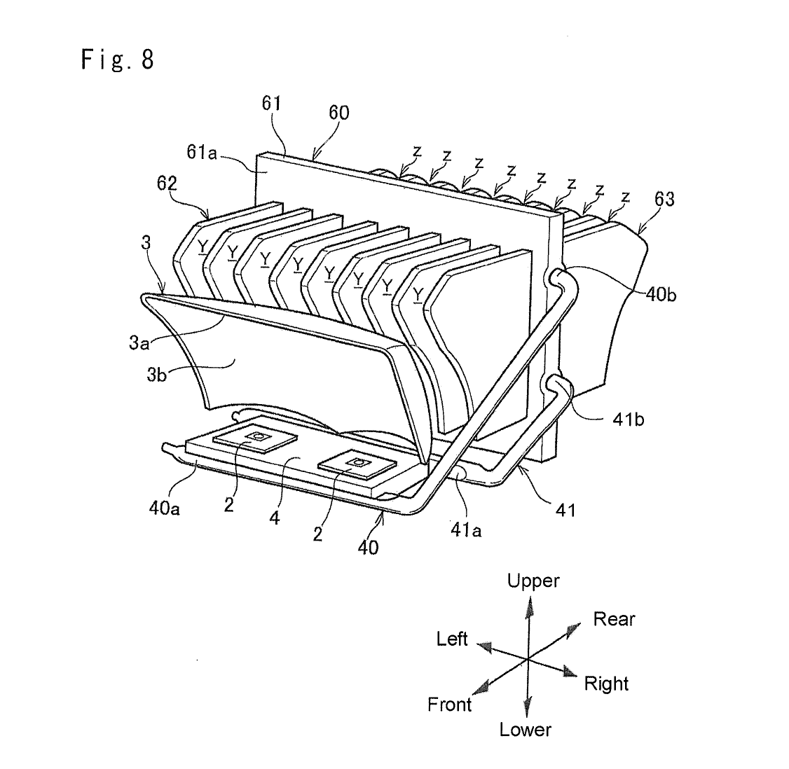

Next, a defrost structure for vehicle headlights according to a third example will be explained with reference to FIGS. 7 and 8. According to the third example, the second example is modified to arrange the fin arrays on both faces of the heat sink. In the third example, the reference numerals used in FIGS. 1 to 6 are also allotted to the common elements, and a detailed explanation thereof will be omitted.

According to the third example, there are two heat pipes 40 and 41 are also arranged in the vehicle headlight 300 shown in FIG. 7. However, only the first heat pipe 40 is shown in FIG. 7 for the sake of illustration. Also, although fin arrays 62 and 63 are erected vertically in a headlight 300 according to the third example, the fin arrays 62 and 63 are illustrated horizontally for the sake of illustration. As shown in FIG. 7, specifically, a heat sink 60 is provided with the inner fin array 62 erected on a front face 61a of a base plate 61, and further provided with the outer fin array 63 erected on a rear face 61b of the base plate 61 to be exposed to the external atmosphere. Remaining elements of the headlight 300 are similar to those of the headlight 200 according to the second example.

As shown in FIG. 8, fins of the outer fin array 63 are juxtaposed vertically, and each clearance between the fins serves as an air flow channel Z allowing air to flow vertically therethrough.

In the outer fin array 63, a vertical length of each fin is also longer than a horizontal length thereof, and each fin is preferably formed to have a high aspect ratio. According to the example shown in FIG. 8, an upper side of each fin is longer than a lower side thereof, however, the fins of the outer fin array 63 may also be formed to have same horizontal lengths of the upper side and the lower side.

In the defrost structure of the third example, heat of the LED 2 transported to the heat sink 60 through the heat pipes 40 and 41 is conducted not only to the inner fin array 62 but also to the outer fin array 63 through the base plate 61. Consequently, the heat of the LED 2 can be radiated not only to the internal atmosphere of the rear space B through the inner fin array 62 but also to the external atmosphere through the outer fin array 63. That is, according to the third example, the chimney effect is also achieved in the air flow channels Z of the outer fin array 63 so that the heat radiation from the base plate 61 to the outside of the housing 10 can be enhanced in comparison with the second example.

Thus, according to the third example, the heat radiation from the base plate 61 to the external atmosphere can be enhanced in addition to the advantages of the foregoing examples. Therefore, the LEDs serving as light sources can be cooled more efficiently.

The defrost structure for vehicle headlights should not be limited to the foregoing preferred examples, and may be modified within the spirit of the present invention.

For example, the heat collection member may also be formed of a conventional vapor chamber (a flat heat pipe) comprising a working fluid encapsulated in a flat sealed container and a wick structure.

In addition, the cooling device of the present invention may also be applied to headlights of any of transportation carriers, e.g., automobiles, railway vehicle, aircraft and so on.

What is claimed is:

1. A defrost structure for a vehicle headlight, comprising:
a light-emitting diode serving as a light source arranged in a housing;
a heat sink comprising a base plate attached to a rear opening of the housing to close the housing hermetically, and a plurality of fins erected vertically on the base plate to protrude forward in the housing;
a heat pipe thermally connecting the light-emitting diode to the heat sink;
a reflector that is disposed in front of the heat sink and that is curved forward from a lower end to an upper end to shroud the light-emitting diode from above; and
an air flow channel that allows air warmed by the fins to flow toward an inner surface of a lens hermetically closing a front opening of the housing through between an upper end of the reflector and a top plate of the housing;
wherein a front side of each of the fin is individually contoured to the rear surface of the reflector, and an upper side of each of the fin is individually aligned with the upper end of the reflector to serve as the air flow channel; and
wherein a surface area of an upper portion of each of the fin is larger than that of a lower portion thereof.

2. The defrost structure according to claim 1, wherein a vertical length of each of the fin is longer than a horizontal length thereof, and the horizontal length of an upper side of each of the fin is longer than that of a lower side thereof.

3. The defrost structure according to claim 1, wherein the heat pipe penetrates through the fins of the heat sink.

4. The defrost structure according to claim 1,
wherein a front face of the base plate serves as an inner wall surface of the housing, and a rear face thereof serves as an outer wall surface of the housing,
wherein the fins are erected on the front face of the base plate, and
wherein the heat pipe is inserted into the base plate of the heat sink.

5. The defrost structure according to claim 1, wherein the heat sink further comprises a plurality of outer fins erected on the base plate of the heat sink to protrude outside of the housing.

6. The defrost structure for vehicle headlights according to claim 5,
wherein the outer fins are erected vertically on the rear face of the base plate of the heat sink, and
wherein a vertical length of each of the outer fin is longer than a horizontal length thereof, and the horizontal length of an upper side of the fin is longer than that of a lower side thereof.
